(19) United States
(12) Patent Application Publication
(10) Pub. No.: US 2007/0168456 A1
(43) Pub. Date: Jul. 19, 2007

(54) Two-way video player transmission system

(75) Inventor: Juen-Tien Peng, Chung Li (TW)

Correspondence Address: HDSL, 4331 STEVENS BATTLE LANE, FAIRFAX, VA, 22033, US

(73) Assignee: Action Electronics Co., Ltd.

(21) Appl. No.: 11/331,215

(22) Filed: Jan. 13, 2006

(51) Int. Cl. G06F 15/16

(52) U.S. Cl. 709/217

(57) ABSTRACT

A two-way video player transmission system includes a video player and at least one client. The video player has a disk reader to read and display the video information on a display. The video player is also operative to transmit sound, text or file to the client in a peer-to-peer transmission way by wireless or wired connection to internet. The video player can also be connected to an internet or network phone for audio communication. The video player has a simple structure with only a few functional keys, such that even the user without the knowledge to operate a computer can easily get access to communicate with another party via internet or internet or network phone.

### BACKGROUND OF THE INVENTION

1. Field of Invention

The present invention relates in general to a transmission system of a video player, and more particularly, to a two-way video player transmission system.

2. Related Art

Recently, the advancement in information technology has successfully developed various storage media, including the compact disk (CD) or digital versatile disk (DVD) recorder, to replace the traditional storage medium such as video tape recorder. The latest type of storage medium has incorporated the display screen therein, such that the video information can be displayed by a single storage medium without the requirement of connecting an external display such as a television.

Although the internet communication has been broadly applied in the modern society, there are still many people resistant or unable to deal with excessive keys in the computer keyboard or complex commands for operating computer. For those who are unfamiliar with operating computers, it is quite a loss for being unable to communicate with another party via many free and real-time domestic long distance or international calling programs. It is therefore a substantial need to develop a video player which includes only a few function keys allowing the user to access the internet phone or perform simple data transmission.

### SUMMARY OF THE INVENTION

A video player having two-way transmission function is provided. The video player is operative to communication another party, namely, a client, via internet, so as to perform peer-to-peer transmission of data, video information, or file. The video player made with a portable dimension compatible to a notebook. As video player is not required to perform equivalent computation or calculation provided by a computer, it is much more afforded compared to a laptop or notebook computer.

The client of the two-way video player transmission system may also include a video player communicable to the internet, such that a two-way transmission can be performed. Alternatively, an internal call can also be performed by connecting to the client via an internet phone or calling program.

Accordingly, the two-way video player transmission system includes a video player and at least one client. The video player is operative to read and play video information stored in a disk on a display. The video player includes a network module for connecting internet, so as to perform peer-to-peer transmission of audio information, text or file. The client is connected to the video player via the internet, so as to establish a two-way data transmission with the video player. The video player has a simple structure with only a few functional keys, such that even the user without the knowledge to operate a computer can easily get access to communicate with another party via internet or internet or network phone.

### BRIEF DESCRIPTION OF THE DRAWINGS

The present invention will become more fully understood from the detailed description given hereinbelow illustration only, and thus are not limitative of the present invention, and wherein:

FIG. 1 shows a block diagram of a two-way video player transmission system; and

FIG. 2 shows an internet video player, a personal computer or a laptop computer at the client.

### DETAILED DESCRIPTION OF THE INVENTION

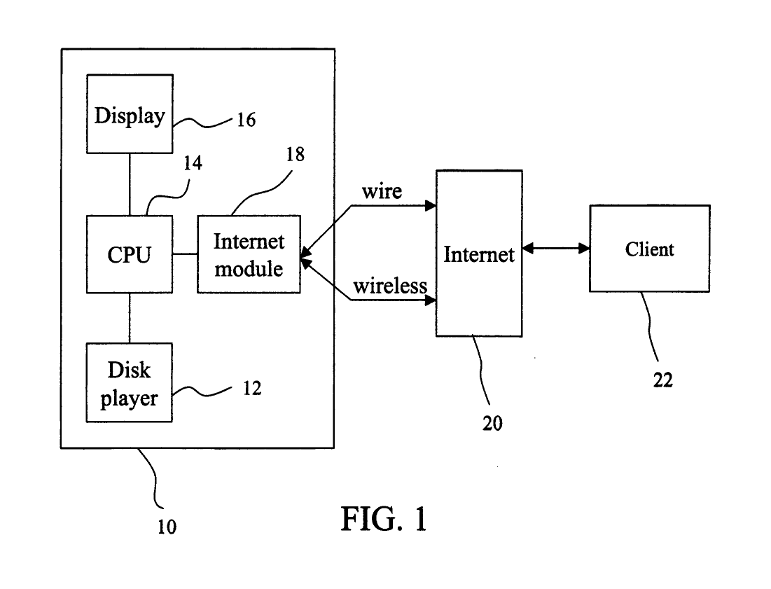

As shown in FIG. 1, the two-way video player transmission system includes a video player 10 which includes a disk player 12, a central processing unit 14, a display 16, and an internet module 18. The video player 10 is preferable made with a portable size compatible to or smaller than a laptop computer. The disk player 12 includes a compact disk (CD) player, a video compact disk (VCD) player or a digital versatile disk (DVD) player. The central processing unit 10 is operative to process operations of all the components of the video player 10. The operation includes reading information save in a compact disk by the disk player 12 and displaying the information on the display 16. The internet module 18 includes a wireless or wired network card for communicating internet 20 by TCP/IP communication protocol. The central processing unit 14 is thus further operative to control the transmission of the information via the internet. The video player 10 may also include a USB connector for connecting an external electronic device thereby and a memory for temporary data storage.

The transmission system further includes a client 22 which includes an internet accessible video player, a personal computer, a notebook computer, an internet phone, a cellular phone, or a domestic phone. A peer-to-peer communication between the video player 10 and the client 22 can be established via the internet 20. If the video player 10 is hooked up to an external network or internet phone, the user can then communicate the client by the internet phone. When the video player 10 is connected to an internet phone, an intermediate signal transformation station such as a internet phone company or telecommunication company can also be hooked up to perform digital/analog signal transmission before transmission the information to the client 22 through the internet 20. The audio signal transmitted from the video player 10 can then be transmitted to a telephone network (PSTN), followed by transmission to a telephone line. Thereby, a telephone communication between the video player 10 and the telephone can be established.

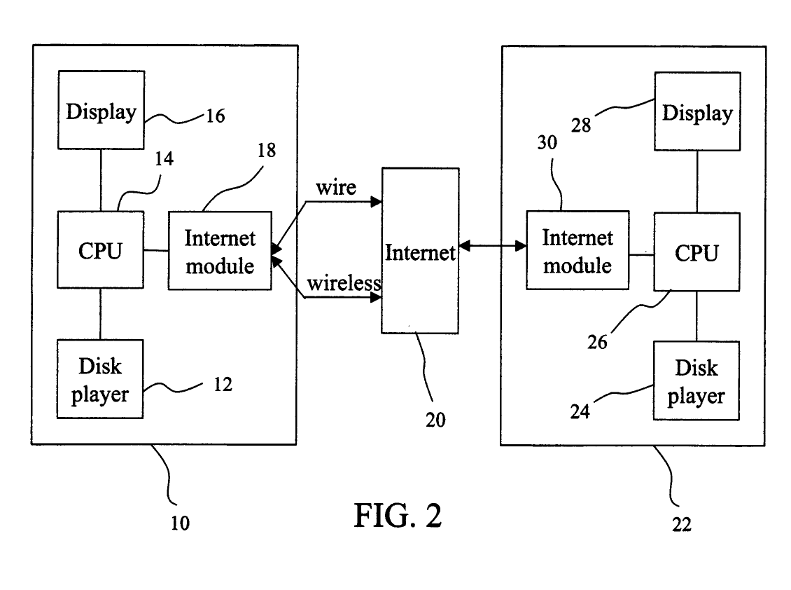

When the client 22 includes an internet accessible or connectible video player, a personal computer or a laptop computer, the two-way communication is illustrated in FIG. 2. When the video player 10 and the client 22 are connected to internet 20 via the respective network modules 18 and 30, the image displayed on the display 16 of the video player 10 can be extracted by the central processor unit 14 and transmitted to the client 22.

Through the central processing unit 26 at the client 22, the image is processed and displayed on a local display 28, such that the user can watch the image currently played by the video player 10. The client 22 is also operative to transmit data to the video player 10.

Accordingly, a two-way video player transmission system as disclosed uses the network module installed at the video player which is currently playing the information contained in a disk, such that a peer-to-peer transmission to a client can be established through internet. The audio information, texts and files can also be transmitted mutually. When the video player is connected to an external network phone, communication can then be established through the network phone line. As the video player has relative fewer operation keys, it is much easier to operate. Therefore, even the user unfamiliar with computer can access the video player.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A two-way video player transmission system, comprising:
a video player operative to read and play video information stored in a disk on a display, wherein the video player includes a network module for connecting internet, so as to perform peer-to-peer transmission of audio information, text or file; and
at least one client connected to the video player via the internet, so as to establish a two-way data transmission with the video player.

2. The system of claim 1, wherein the video player further comprises a USB slot to electrically an external device having a USB connector.

3. The system of claim 1, wherein the video player further comprises a disk reader to read the information stored therein.

4. The system of claim 1, wherein the network module includes a wired or wireless network card.

5. The system of claim 1, wherein the video player includes at least one memory device for storing data.

6. The system of claim 1, wherein the customer includes an internet accessible video player, a personal computer, a laptop computer, a domestic telephone or an internet phone.

7. The system of claim 6, wherein when the client includes an internet accessible video player, a personal computer or a laptop computer, the video player is operative to extract and transmit an image displayed on the display to the client, so as to allow a user a the client to simultaneously watch the image.

8. The system of claim 1, wherein the video player is operative to connect an external network phone via the network module.

9. The system of claim 1, wherein the video player includes a portable video player.
